(19) United States
(12) Patent Application Publication
(10) Pub. No.: US 2024/0202847 A1
(43) Pub. Date: Jun. 20, 2024

(54) BLOCKCHAIN-GIS BASED FRAMEWORK FOR LAND REGISTRATION

(71) Applicant: University of Florida Research Foundation, Inc., Gainesville, FL (US)

(72) Inventors: Belay Alem, Gainesville, FL (US); Oluwatoyin Lawal, Gainesville, FL (US); Nawari O. Nawari, Gainesville, FL (US)

(21) Appl. No.: 18/541,637

(22) Filed: Dec. 15, 2023

Related U.S. Application Data
(60) Provisional application No. 63/387,583, filed on Dec. 15, 2022.

(51) Int. Cl. G06Q 50/16; G06Q 50/18

(52) U.S. Cl. CPC G06Q 50/167; G06Q 50/18

(57) ABSTRACT

The present disclosure presents blockchain-GIS based systems and methods for land registration. One such method, among others, comprises receiving, by one or more computing devices on a distributed ledger network, a land parcel record comprising geocoded information with a georeferenced map of the land parcel; validating, by the one or more computing devices using a smart contract, the land parcel record against a geo-spatial description of the land parcel in one or more municipal records; adding, by the one or more computing devices, the land parcel record as a block in a distributed ledger of the distributed ledger network with other land parcel records of the municipality; and transmitting, by the one or more computing devices, an electronic confirmation of ownership of the land parcel to the landowner.

### CROSS-REFERENCE TO RELATED APPLICATION

This application claims priority to co-pending U.S. provisional application entitled, “Blockchain-GIS Based Framework for Land Registration,” having application number, filed Dec. 15, 2022, which is entirely incorporated herein by reference.

### BACKGROUND

Land asset is arguably one of the largest assets of an individual. The physical representation of land extents has been the most common way to store cadastral records. These records are centrally held within the municipality with each stakeholder having a duplicate information pertaining only to their own asset, without any knowledge of other neighboring assets. Thus, the accuracy of land ownership and cadastral information has been reliant upon a centralized catalog of municipal records and its distributed duplicate copies in property owner's possession. For many years, the analogous centralized records are the only repository of accurate information of land ownership and are yet susceptible to mutation.

Exemplary U.S. Patent documents in the prior art include the following. U.S. Pat. No. 11,803,923 for “BLOCKCHAIN-BASED SYSTEM AND METHOD FOR PURCHASE DOCUMENT TRANSFORMATION AND ACCOUNTABILITY” by Edward Wu, et al., filed Sep. 4, 2019, describes a method that deals with real estate documentation and transactions. As described in this patent, the major data source involves populating a form manually (or electronically) and the major actors include real estate buying agents, buyers, and brokers. A blockchain is deployed in this invention to ensure compliance due to the large amount of documentation required. The blockchain is also used for the unification of document storage and checking of compliance of documents in real estate transactions to prevent the likely errors of relying on humans to check a large number of documents by separating public and private documents into data blocks to be accessed by super nodes.

U.S. Patent No. US 2006/0116952 for “SYSTEM AND METHOD FOR CREATING ELECTRONIC REAL ESTATE REGISTRATION,” by Michael Dell Orfano, filed Nov. 30, 2005, describes a method for management of a land registration database using coordinates particular to the parcel of land. This invention focuses on computer-based methods and systems for originating and managing electronic real estate transactions, land price calculations, and registrations, and pertains to systems and methods for valuing, pricing, acquiring, and electronically recording real estate interests. This invention uses a conventional central database approach to facilitate transactions among and between capital market and real estate market participants and aims to provide the capital and real estate markets with alternative financial instruments that reduce economic risks, improve transactional transparency, and limit real estate market price breaks.

U.S. Patent No. US 2019/0050491 for “SYSTEMS AND METHODS FOR MANAGING AND DELIVERING REAL PROPERTY DATA” by Chris Mask, et al., filed Aug. 10, 2017, describes techniques for rendering real estate property parcel data. This invention involves a central database server component that retrieves parcel information in response to user requests and authenticates user identification. The server then provides parcel data for display on a unique user web page, including parcel mapping that combines dynamic and static data to form a parcel map in response to the user's query. The invention focuses on: (a) An Application Programming Interface (API) to deliver property information to users via a web browser in which the system then connects to a parcel information database, displaying preselected parcel data endpoints; (b) Data Aggregation and Conversion—A system for aggregating actual property parcel data from multiple sources, converting the data to meet API requirements, and storing it in a central parcel information database; (c) Dynamic and Static Data Integration—Techniques for integrating dynamic parcel data with static map images, allowing users to view real-time property information on a map; (d) User Interaction with Data—Systems that allow users to search for parcel data using various criteria, view results on a unique webpage, and interact with the data, including ordering, saving, and generating reports; (e) Charging Mechanism—A method for generating charges based on user interaction with the parcel data, calculated via the web interface and API implementation; and (f) User Authentication and Customization—Authentication of users through a custom web interface, with options for users to customize their searches and results display.

U.S. Patent No. US 2022/0351314 for “SYSTEMS AND METHODS FOR MANAGING REAL ESTATE TITLES AND PERMISSIONS” by Bennett Hill Branscomb, et al., filed on Jul. 14, 2022, focuses on systems and methods for managing real estate titles and permissions using electronic devices. This system aims to centralize and manage various rights and entitlements associated with real estate, leveraging technology to enhance control and accessibility of property-related information. Key aspects include: (a) Real Estate Titles and Permissions Platform—A platform including a database with master keys associated with geographic designators, titles, and permissions. This platform is designed to display titles or permissions upon receiving a request from the geographic designator; (b) Management of Virtual Space—The platform manages virtual space and titles related to real estate, providing a centralized database system for real estate transactions; (c) Prohibition and Permission Keys—The system involves keys associated with prohibitions or permissions related to geographic designators. These keys can be transferred or duplicated by the owner; and (d) Functionality Control Based on Location—The method includes providing a key to electronic devices, which allows them to perform functions based on their location relative to real property boundaries, such that the patent aims to manage real estate titles and permissions using digital technology, emphasizing control and encryption.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a blockchain-based land registration workflow for an exemplary crypto-spatial coordinate land registration system in accordance with embodiments of the present disclosure.

FIG. 2 shows land parcel information that can be stored as part of the crypto-spatial coordinate land registration system of the present disclosure.

FIG. 3 shows a blockchain-based land registration workflow for an exemplary crypto-spatial coordinate land registration system in accordance with embodiments of the present disclosure.

FIG. 4 shows a representation of an exemplary Geographical Information System (GIS) map that can be generated as part of the crypto-spatial coordinate land registration system of the present disclosure.

FIG. 5 shows a blockchain-based land registration workflow for registration of split land parcels for an exemplary crypto-spatial coordinate land registration system in accordance with embodiments of the present disclosure.

FIG. 6 shows a schematic block diagram of a computing device that can be used to implement various embodiments of the present disclosure.

### DETAILED DESCRIPTION

In recent years, scholarly endeavors on the deployment of blockchain technology in land registration has been well documented. Blockchain enhanced Geographical Information System (GIS) has also found a number of use cases in fields such as supply chain, healthcare, and border violation detection. The present disclosure redefines the concept of trust by combining the above unique concepts, namely: GIS, distributed ledger technology (e.g., blockchain), and land registration to provide immutable and secure ownership records without a centralized authority.

In accordance with the present disclosure, the immutability and decentralized information strata of distributed ledger or blockchain technology is deployed to develop a crypto-spatial coordinate land registration system and method, which is absent in the regular blockchain-based land registration system, such that geocoded information (e.g., geographic coordinates) of selected landowners and their respective land locations is combined with georeferenced maps (e.g., map is related or oriented to a geographic coordinate system) of each land unto a distributed ledger with the landowners all on the distributed ledger network. A geospatial-enabled blockchain model of the present disclosure comprises two major components: the GIS database and the distributed ledger technology (DLT) model along with Smart Contract (SC) that focuses on validating transactional data. Accordingly, the GIS database presents a unique and improved format for recording and storing land parcel record data on the ledger, and the DLT model deals with communication between stakeholders or landowners and the transaction records. As such, embodiments of the present disclosure provide a solution to longstanding issues regarding registration of land that include the accurate storage of land parcel records, information and transactions, as addressed by distributed ledger technology, and the accuracy of title, deed, and legal description of land expanses, as addressed by geographical information systems.

A smart contract (SC) is a Chaincode service which is an application-level code stored on the ledger as a part of a transaction. SC runs transactions that may modify the data on the ledger. Chaincode is installed on network members machines, which require access to the asset states to perform read and write operations. The SC is then instantiated on a particular node for specific peers to validate the required data. Ledgers are normally shareable across entire networks of peers or include only a specific set of participants. Peers can participate in multiple BC (blockchain) channels.

In a typical distributed ledger technology (DLT) network, the entire processing and storage of data are performed in nodes that are hosted and supervised by local stakeholders. Also, the changes applied to the data are made implicitly immutable by appropriate cryptographic linking. This offers a sequential record of the following state(s) the data is in, along with the individual changes, in a transparent way. The progression over time can be recorded in more detail with the attachment of timestamps to individual modifications. DLT relies on consensus building, which refers to algorithms that enforce the data's validity and changes and are replicated on multiple distributed nodes in the network.

Thus, via distributed ledger technology and SC, an exemplary crypto-spatial coordinate land registration system of the present disclosure is secure and transparent as blockchain technology is immutable and requires the consent of miners to correct an erroneous addition to the ledger. Its information is distributed across different nodes, making the system less prone to malicious attacks contrary to currently available systems of land registry where there is a single point of control. The entries in the database are transparent to all authorized participants and most importantly, the integrity of the system is guaranteed by the application of cryptographic means of securing information.

In various embodiments, GIS-assisted blockchain-based land registration, using an exemplary crypto-spatial coordinate land registration system, incorporates a unique identity code of a certain expanse of land on the earth's surface. As such, GIS-based blockchain technology can be used for both land documentation and title registration giving stakeholders better insight on the nature of transactions pertaining to the land.

Traditionally, land registration management authorities or companies may issue a legal document evidencing ownership right or ownership itself to more than one person or entity with no means of the affected person or entity to detect such an error. The interests come to conflict when both or multiple owners or document holders start exercising their rights on the land. The authentication process is often very stringent to avoid fraudulent entry of the land parcel record in the land registry. Authentication in the case of paper-based registration typically takes place in the presence of witnesses appearing in person at the title or document registration office to put signature before the office that is authorized to authenticate the documents. This is because in some cases, particularly registration of documents (document evidencing ownership), invalidity of the first transaction will cause invalidation of chain of transfers that take place for decades. However, in the case of the registration of ownership, subsequent registrations and transfers will remain valid regardless of fraud involved as far as the recipients in the transaction can prove that they acted in a good faith.

However, with an exemplary crypto-spatial coordinate land registration system and method, after a one time entry (on the distributed ledger) of a uniquely coded parcel using GIS, and Smart Contract (SC) to validate all data related to the land or property (such as outstanding mortgages, other debts secured by the land or property, unpaid Homeowners Association dues, unpaid property or income tax Liens, mechanic's liens, restrictions, lease, levy, and easement), the next authentication would be digital and would take place in a transparent and participatory way so that the possibility that counterfeit authentication and registration would be almost null. This validation includes the title abstract, title search, and title insurance. Title abstract is a legal document that outlines the ownership history of a particular land or property. It includes all records related to inheritance, court litigation and tax sales as well). In various embodiments, GIS based blockchain registration can be performed using a digital signature and time stamp allowing a smooth flow of transactions.

As mentioned, the immutability of a distributed ledger or blockchain can provide the necessary transparency in land registration. For example, most land disputes arise from boundaries. In a traditional paper-based land registration, boundaries to the ownership of a certain parcel are marked based on physically exiting things in every direction. For instance, the ownership title for parcel A could be identified as: “2 acres of land located in East Addis Ababa with the Following boundaries:
1. East: Anwar Mosque (biggest mosque in Ethiopia)
2. West: Toyin's Farmland
3. North: Belay's house
4. South: Monica's Shop”

This kind of physical boundary-based land registration is very problematic and the problem is prevalent in developing regions. The first problem comes when these all boundaries disappear for whatever reasons. ‘Anwar Mosque’ may be relocated to the other part of the city. ‘Toyin’ may also change the purpose of his farmland to small industry. ‘Belay's house’ and ‘Monica's shop’ may be destroyed in the future. Therefore, none of these boundaries are permanent. For another, these kinds of boundaries are set only for cardinal directions, which always assume rectangular plots. In this case, it is hard to resolve land disputes that come from claims of pushing boundaries, encroachments, or easements, in the northwest, southwest, southeast, and northeast. Thus, a blockchain-based land and property registration system can have a higher efficiency and accuracy with geo-specific cadastral information and SC to provide secured and reliable land or property ownership in decentralized and immutable records.

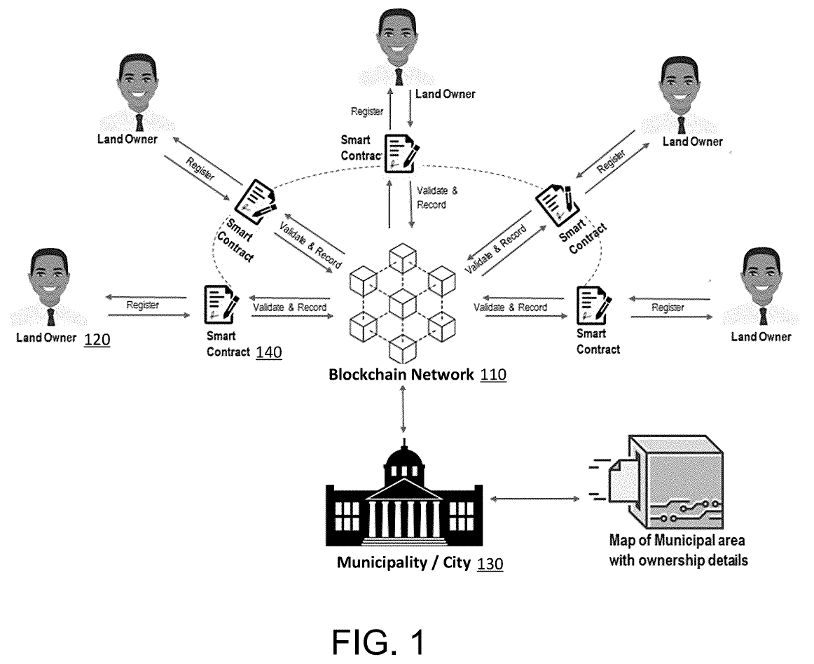

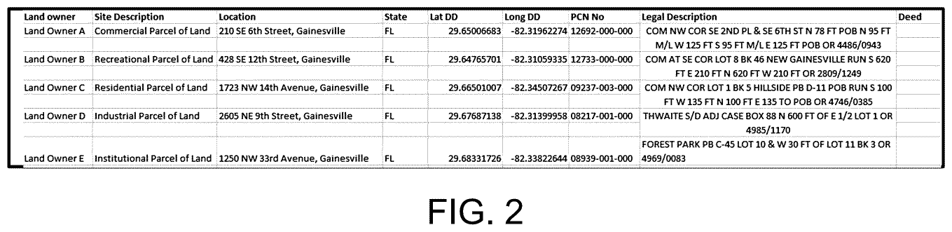

In accordance with various embodiments, FIG. 1 shows a blockchain-based land registration workflow. From FIG. 1, each participant registers unto the blockchain network 110 with a unique identification key. Upon registration, the blockchain network 110 prompts the land owners 120 to enter information regarding their land or asset(s). Correspondingly, a municipality or city representative entity 130 can also submit land or asset information, such as a map of the municipal area with ownership details. As such, the inputted information can comprise data on land and landowners, such as land locations, coordinates, land sizes, acquisition dates, outstanding mortgages, other debts secured by the land or property, unpaid homeowners association dues, unpaid property or income tax liens, mechanic's liens, restrictions, lease, levy, and easement, previous owners, and current ownership information, as represented in FIG. 2. These additional pieces of information can be a part of the title search along with the title insurance.

In various embodiments, the parcel land location and size information is converted into a GIS format and a GIS map is created of the parcel location. The longitude and latitude information provides a unique identification for each land to avoid double registration of the same parcel of land. Symbology and labels can be used to analyze land information quantitatively with respect to land sizes, quantities per owner, etc. Accordingly, for each landowner in a municipality, GIS maps can be created from the vector components (points, lines, polygons) associated with each land parcel belonging to each owner and can show the parcels of land with reference to surrounding landmarks to establish distances and bearings between land boundaries and these landmarks. These GIS maps validate any existing survey and legal description of the land or property.

In various embodiments, the provided and created information is validated by the SC in the blockchain network 110 and recorded to its blockchain ledger. In particular, this information is stored by a blockchain network via a consensus mechanism involving other stakeholders. This consensus provides the novel transparency. For validation to be successful, in addition to the consensus, the information from the land or property owner is cross-referenced with municipal records to ensure that the GIS-generated information is in consonance with that of the city database in terms of geo-spatial descriptions. Upon validation of all other related data, electronic confirmation of ownership is issued to the landowner via automated smart contracts 140. Each participant or landowner will be able to retrieve their copy of the ownership documents pertaining to their land or property.

In various embodiments, the distributed ledger or blockchain network can be public or private. As a non-limiting example, the distributed ledger network can comprise a private blockchain network with nodes to represent all landowners. In various embodiments, the private blockchain network uses a Hyperledger fabric as its distributed ledger technology. Maps developed earlier and their ownership information are added into the distributed ledger of the blockchain. This enables all recorded geospatial information to be cryptographically recorded in blocks of immutable data. In various embodiments, this blockchain is managed by the municipality and all entities added to the network is guaranteed to remain as such. Any alteration to a cadastral information will be visible to the entire blockchain network 110 and a consensus will have to be reached by more than 50% of the blockchain network 110 for the alteration to be added to the ledger. Accordingly, consensus enables a trust system. The consensus service permits digitally signed transactions to be proposed and validated by network members. Additionally, the consensus is normally pluggable and tightly linked to the endorse-order validation model that the Hyperledger proposes.

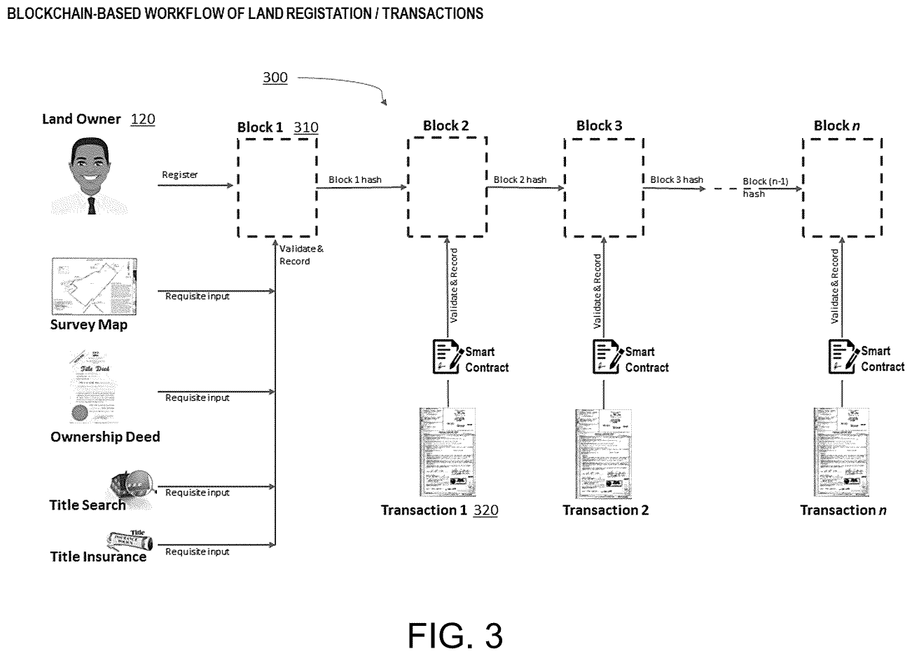

As illustrated in FIG. 3, successful registration and validation make up a block 310 in the blockchain ledger 300, that is encrypted by a hash and a time stamp, and subsequent transactions 320 regarding that land will be represented in a separate block 330, linked to the hash of the previous block 310, to ensure a continuous chain of ledgers. All of this information is accessible to any other member of the blockchain network 110 upon authorization of the municipality 130, which plays the role of an administrator of the private blockchain network 110.

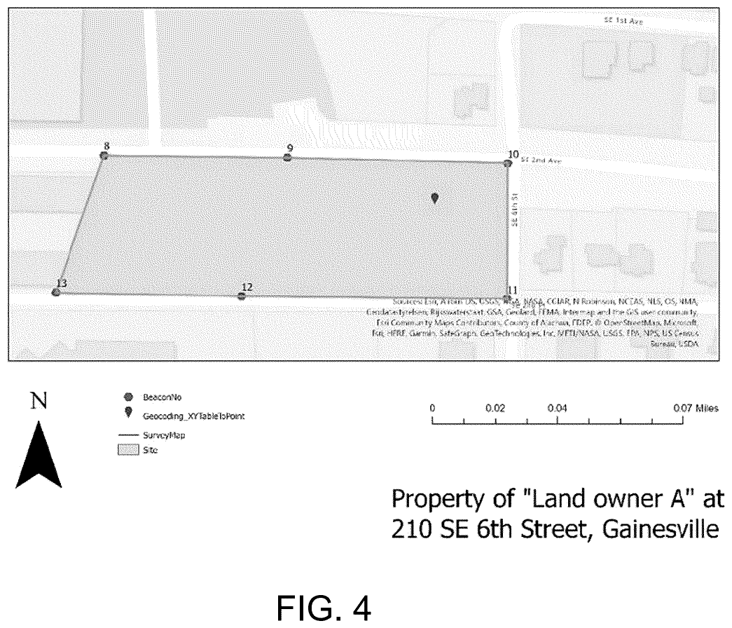

FIG. 4 shows a representation of an exemplary GIS map that can be generated for every landowner's asset and stored on the municipal records in the blockchain network 110. Such maps are synchronized with the layout of all land and property owners in a geographic area or municipality to ensure that information available to the public about their assets is in accordance with the municipal records.

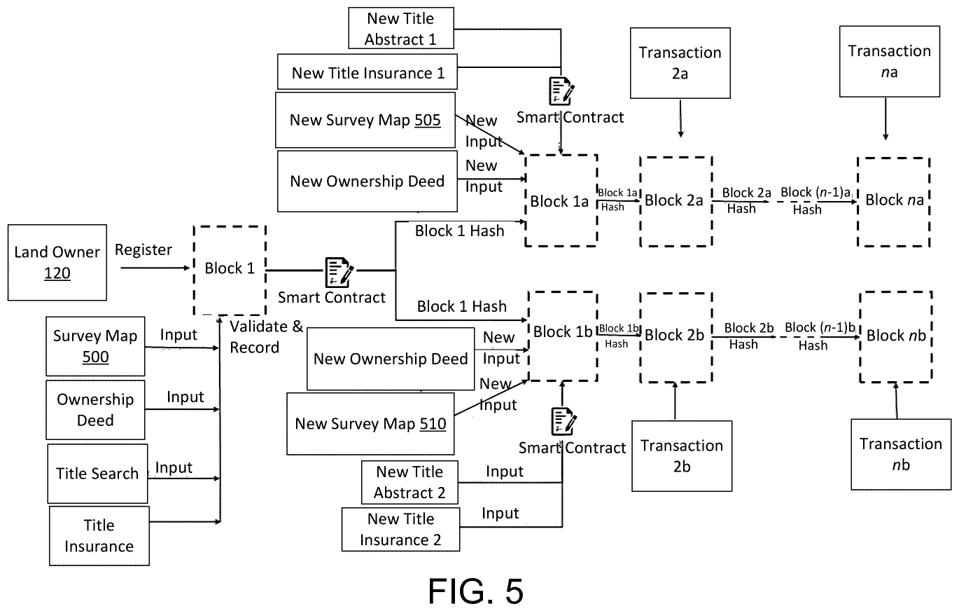

Crypto-spatial coordinate land registration system and related methods can be helpful in a variety of applications, including the case of splitting and merging land parcels. Accordingly, the plot of land could be divided, subdivided, and merged for various reasons. For instance, splitting could happen when an original owner dies testate (with a will and last testament) that splits and inherits land to their 2 or more children. Another circumstance of having such case is when the owner sells and transfers the land to more than one person. Consequently, as shown in FIG. 5, the land will require two GIS maps 505, 510 for its future identity depending on the number of splits in the chain of ownership. The original map 500 will stay stored in the blockchain 110 and serve as a reference point to convince that the new smaller maps 505, 510 (stored in subsequent blocks of the blockchain ledger) are derived from the previous larger map (stored in a prior block in the blockchain ledger). Any related Parcel Control Number (PCN)/Folio number and legal description will be stored in subsequent blocks of the blockchain ledger as well.

In a similar manner, a merger could happen when multiple transactions result in one landowner acquiring multiple land parcels from neighboring landowners. For instance, an individual might acquire 3 bordering parcels with each having a different parcel PCN on the blockchain ledger through donation, purchase, and inheritance. Instead of having different GIS maps and title for all of them, the new landowner might want them to be merged into one map and a single parcel code. In this case, all individual parcel PCNs and maps should be maintained on the blockchain ledger to evidence that the new combined parcel map and boundaries are derived from the older small individual maps.

In summary, the present disclosure explores a tripod relationship between GIS, blockchain, and land registration & management by introducing crypto-spatial coordinate land registration systems and related methods. Such systems and methods not only provide an immutable, tamper-proof land database, but also unifies cadastral management across the globe through GIS, thereby eliminating the potentials for erroneous description of any portion of the earth surface through geolocation. Use of either a computer, tablet, smartphone, etc. enables an authorized owner to land parcel data and information in the blockchain network. The reasons and illustrations mentioned above strongly indicate that crypto-spatial coordinate land registration will eliminate errors and reduce land boundaries disputes. This exemplary system will reduce costs and time and improves efficiency and performance of any real estate transactions.

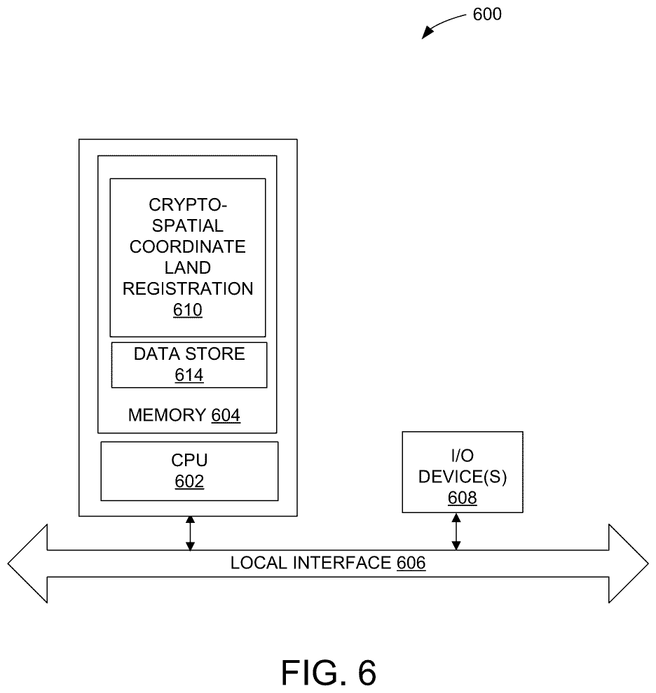

FIG. 6 depicts a schematic block diagram of a computing device 600 that can be used to implement various embodiments of the present disclosure. An exemplary computing device 600 includes at least one processor circuit, for example, having a processor (CPU) 602 and a memory 604, both of which are coupled to a local interface 606, and one or more input and output (I/O) devices 608. The local interface 606 may comprise, for example, a data bus with an accompanying address/control bus or other bus structure as can be appreciated. The CPU 602 can perform various operations described herein.

Stored in the memory 604 are both data and several components that are executable by the processor 602. In particular, stored in the memory 604 and executable by the processor 602 are crypto-spatial coordinate land registration code 610 as described herein and possibly other related software or code, such as a GIS engine (e.g., ArcGIS® software). Also stored in the memory 604 may be a data store 614 and other data. In addition, an operating system may be stored in the memory 604 and executable by the processor 602. The I/O devices 608 may include input devices, for example but not limited to, a keyboard, mouse, communication adapters and/or transceivers, etc. Furthermore, the I/O devices 608 may also include output devices, for example but not limited to, a printer, display, etc.

Certain embodiments of the present disclosure can be implemented in hardware, software, firmware, or a combination thereof. If implemented in software, crypto-spatial coordinate land registration logic or functionality are implemented in software or firmware that is stored in computer-readable medium (e.g., a memory) and that is executed by a suitable instruction execution system. If implemented in hardware, crypto-spatial coordinate land registration logic or functionality can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette or drive (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical).

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A method comprising:
receiving, by one or more computing devices on a distributed ledger network, a land parcel record comprising geocoded information for at least a legal description and deed of a land parcel or a property of a landowner in a municipality with a georeferenced map of the land parcel;
validating, by the one or more computing devices using one or more Smart Contracts (SCs), the land parcel record against a geo-spatial description of the land parcel in one or more municipal records;
adding, by the one or more computing devices, the land parcel record as a block in a distributed ledger of the distributed ledger network with other land parcel records of the municipality; and
transmitting, by the one or more computing devices, an electronic confirmation of ownership of the land parcel to the landowner.

2. The method of claim 1, wherein the distributed ledger network comprises a permissioned blockchain network, wherein a municipality authority administers the permissioned blockchain network.

3. The method of claim 1, further comprising adding, by the one or more computing devices, a second land parcel record involving a sale of the land parcel or a property to a new landowner as a new block to the distributed ledger, wherein the new block is linked to a hash of the block involving the landowner that owned the land parcel previously.

4. The method of claim 1, wherein the one or more Smart Contracts in the distributed ledger network is invoked to validate transaction data of a sale of the land or property and submit a result to the distributed ledger.

5. The method of claim 1, wherein the georeferenced map is formatted using a Geographical Information System.

6. The method of claim 5, wherein the georeferenced map is synchronized with a municipality layout of land parcels owned by landowners of the municipality.

7. The method of claim 1, wherein the land parcel record further includes a survey, an abstract of a title of the land parcel, title search results, title insurance, an acquisition date of the land parcel by a current landowner, current owner information for the land parcel, previous owners information for the land parcel.

8. The method of claim 1, further comprising creating, by the one or more computing devices, the georeferenced map based on the geocoded information.

9. The method of claim 1, wherein the one or more computing devices comprise distributed nodes of the distributed ledger network.

10. A system comprising:
at least one processor; and
memory configured to communicate with the at least one processor, wherein the memory stores instructions that, in response to execution by the at least one processor, cause the at least one processor to perform operations comprising:
receiving, by one or more computing devices on a distributed ledger network, a land parcel record comprising geocoded information of a land parcel of a landowner in a municipality with a georeferenced map of the land parcel;
validating, by the one or more computing devices, the land parcel record against a geo-spatial description of the land parcel in one or more municipal records;
adding, by the one or more computing devices, the land parcel record as a block in a distributed ledger of the distributed ledger network with other land parcel records of the municipality; and
transmitting, by the one or more computing devices, an electronic confirmation of ownership of the land parcel to the landowner.

11. The system of claim 10, wherein the distributed ledger network comprises a permissioned blockchain network, wherein a municipality authority administers the permissioned blockchain network.

12. The system of claim 10, wherein the operations further comprise adding a second land parcel record involving a sale of the land parcel or a property to a new landowner as a new block to the distributed ledger, wherein the new block is linked to a hash of the block involving the landowner that owned the land parcel previously.

13. The system of claim 10, wherein the one or more computing devices are configured to invoke a smart contract in the distributed ledger network to validate transaction data of a sale of the land or property and submit a result to the distributed ledger.

14. The system of claim 10, wherein the georeferenced map is formatted using a Geographical Information System.

15. The system of claim 14, wherein the georeferenced map is synchronized with a municipality layout of land parcels owned by landowners of the municipality.

16. The system of claim 10, wherein the land parcel record further includes an acquisition date of the land parcel by a current landowner, current owner information for the land parcel, or previous owners information for the land parcel, wherein owner information includes outstanding mortgages, unpaid Homeowners Association dues, unpaid property or income tax Liens, mechanic's liens, restrictions, lease, levy, easement, abstract of a title of the land parcel, and title insurance.

17. The system of claim 10, wherein the operations further comprise creating the georeferenced map based on the geocoded information.

18. The system of claim 10, wherein the one or more computing devices comprise distributed nodes of the distributed ledger network.

19. A non-transitory, tangible computer readable storage medium having instructions stored thereon that, in response to execution by a computer-based system, cause the computer-based system to perform operations comprising:
receiving, on a distributed ledger network, a land parcel record comprising geocoded information of a land parcel of a landowner in a municipality with a georeferenced map of the land parcel;
validating the land parcel record against a geo-spatial description of the land parcel in one or more municipal records;
adding the land parcel record as a block in a distributed ledger of the distributed ledger network with other land parcel records of the municipality; and
transmitting an electronic confirmation of ownership of the land parcel to the landowner.

20. The non-transitory, tangible computer readable storage medium of claim 19, wherein the operations further comprise:
adding a second land parcel record involving a sale of the land parcel or a property to a new landowner as a new block to the distributed ledger, wherein the new block is linked to a hash of the block involving the landowner that owned the land parcel previously,
wherein a smart contract in the distributed ledger network is invoked to validate transaction data of the sale of the land or property and submit a result to the distributed ledger.
